(19) United States
(12) Patent Application Publication
(10) Pub. No.: US 2013/0284462 A1
(43) Pub. Date: Oct. 31, 2013

(54) Home safety kit

(71) Applicant: Peter Cordani, Palm Beach Gardens, FL (US)

(72) Inventor: Peter Cordani, Palm Beach Gardens, FL (US)

(21) Appl. No.: 13/928,007

(22) Filed: Jun. 26, 2013

Related U.S. Application Data
(63) Continuation-in-part of application No. 12/887,230, filed on Sep. 21, 2010.

(51) Int. Cl. A62C 5/00; A62C 25/00

(52) U.S. Cl. CPC A62C 5/002; A62C 25/005
USPC 169/15

(57) ABSTRACT

An apparatus for enhancing the fire extinguishing properties of water for use in combination with a pressure washer. The pressure washer distribution wand includes a high pressure nozzle attached to the discharge end of the wand. The nozzle is positioned in a mixing chamber adjacent to an inlet coupled to a source of dry polymeric material. The velocity of the water exiting the high pressure nozzle vacuums the polymeric material through a pick-up tube into the mixing chamber for admixing with the pressurized water without clogging. The mixture of water and polymeric material is discharged through another nozzle. The system provides a means for a homeowner to quickly modify an existing pressure washer into a distribution system of a mixture that enhances the fire resistance of structures, vegetation, or any other combustible matter.

### CROSS REFERENCE TO RELATED APPLICATION

In accordance with 37 C.F.R. §1.76, a claim of priority is included in an Application Data Sheet filed concurrently herewith. Accordingly, the present invention claims priority as a continuation-in-part of U.S. patent application Ser. No. 12/887,230, entitled “HOME SAFETY KIT”, filed Sep. 21, 2010. The contents of the above referenced application is incorporated herein by reference in its entirety.

### FIELD OF THE INVENTION

This invention relates to the field of fire prevention and more particularly to use of a dehydrated super absorbent polymer in combination with a pressure washer to coat structures to inhibit fire from spreading to the structures.

### BACKGROUND OF THE INVENTION

Structures are susceptible to fire, some more than others. Fires can be caused from most any source but one of the most problematic fires is caused when a forest or other vegetation catches fire and a wind accompanies the fire. Such fires are a common occurrence and can easily be started by a lightning strike or the result of a human occurrence. In any event, as the general population continues to build structures in close proximity to large vegetative sources, more and more structures are placed at risk. Unfortunately the number of fire fighters to structures is not proportionate and is getting worse, not better.

Homes abutting a forest or other large vegetation areas are safe as long as the moisture content of the vegetation remains high. Should the vegetation become dry, the vegetation becomes fuel that can support a fire. For instance, while the Florida Everglades may be considered one of the most tropical areas in the United States, during a drought the everglades can catch fire and homes built near the everglades are susceptible to fire damage. Homes in Southern California may abut rugged areas filled with dead brush which can easily support the spread of a fire. Thousands of acres are consumed by fire each year and structure damages are increases as the population grows.

A raging fire can create its own environment with up-drafts and winds that can cause embers to carry to areas otherwise distant from the fire. Southern California is particularly susceptible to embers being carried when the Santa Anna winds occur. The result is that embers can be carried with the wind distributing potentially hazardous fire starters towards homes that would otherwise not be directly next to the forest or brush area. In many instances the homes include wood construction, such as wood shake shingles, which can easily catch fire should hot ember land upon the structure. If the owner of the structure is not in an evacuation zone, the owner may be an able bodied individual who can inhibit spreading of the fire to their structure by keeping high moisture content on the wood.

It is well known that the damage from many natural events can be reduced or eliminated with proper preparation. For instance, the owners of a structure may prepare for a hurricane at the last minute by installing window covers. Those in a fire zone may also be prepared to protect their structure but, unlike a hurricane, the path may be very small and the homeowner may have only a short notice that their structure is in harm's way. The danger of a fire is that while one structure may be located a distance from the fire, it may still catch fire while a structure closer to the fire does not catch fire. For these reasons, most homeowners attempt to protect their structure by using fire resistant products in the construction or repair of their buildings. In many instances the homeowners are not prepared for a fire due to lack of proper tools or funding to protect their structure when an actual fire is approaching. This lack of preparation places adjoining structures at risk.

The most commonly used item in protecting a structure is water. In fact, it is not uncommon to see a homeowner standing on their roof with a garden hose attempting to add moisture to the roof. Unfortunately, the quick evaporation of water due to low humidity and high temperatures can defeat the effort. Water has been known for its fire retardant and extinguishing properties and remains the predominate material used to extinguish or prevent certain types of fires. Water has a high heat capacity and high heat of vaporization, such that when water is sprayed onto a fire, the water that reaches the flames absorbs the heat of the fire and cools the article to below its combustion temperature. Water also deprives the fire of oxygen. Often the heat of the fire turns a portion of water into vapor before it can reach the flames. Since water vapor is heavier than air it displaces the oxygen surrounding the fire, thereby suffocating the fire.

A significant disadvantage often encountered using water to extinguish a fire is that much of it ends up wasted. Water applied directly to the fire mostly evaporates before it can reach the base of the fire, where the combustible fuel for the fire resides. As much as 90 to 95% of the water that does manage to reach the flames simply runs off into the ground. Moreover, considerable effort must be made to continuously soak objects with water near the fire that could ignite as the water evaporates very quickly. In order to maintain protection of the objects from fire the evaporated water must be constantly replaced.

Homeowners are very adept at protecting their homes if they are provided with access to the right materials. Those in a fire zone also attempt to protect their structures but need access to a variety of materials to treat a variety of conditions. For instance, a fire may be accompanied by a high wind that makes standing on a roof with a hose very dangerous. Should the fire turn toward the home the individual could be trapped on the roof. Should the winds pick up, the homeowner could slip on the now slickened roof, or the ladder used to access the roof could fall over.

The most exposed portion of any structure is typically the roof. For this reason a number of prior art devices are directed to the treating of a roof with water should a fire approach. For instance, U.S. Pat. No. 3,583,490 discloses a fire protection system for roofs. The system is for wetting the exterior surface of a building structure to prevent ignition of a fire in the vicinity of the structure. The protection system employs a recirculation water system directing water over both the roof and sidewalls of the structure and an automatic fire detection and control system for activating the water system in response to a fire and terminating operation of the water system when the fire is extinguished. A feature of this system is the collection of water from a rain gutter which is returned to a collection point, such as a swimming pool, for further distribution.

U.S. Pat. No. 4,330,040 discloses a fire prevention and cooling system including a main supply tube and a main dispensing tube for wetting a structure. The dispensing tube is U-shaped and is connected to the supply tube via a series of feed lines. The system includes elements to acquire water from alternative sources such as a pool or a tub and secondary tubes for wetting side walls.

U.S. Pat. No. 6,167,971 discloses a fire protection system for a building having a periphery with a roof situated thereon. The roof is supported by rafters which are angled downwardly from a ridge to an eave which extends beyond the periphery of the building a predetermined distance. Included are a water supply and a plurality of supply pipes connected at a first end thereof extending to the building such that the water may flow from the reservoir tank to the building. Also included is a plurality of above ground distribution pipes. The above ground distribution pipes include at least one vertical pipe situated on the periphery of the building with a lower end thereof connected to a second end of the underground pipe and a plurality of horizontal pipes connected to an upper end of the vertical pipe and extending along the length of the eave on an underside thereof. A plurality of sprinklers are connected to the horizontal pipes to spray water upwardly towards the rafters and downwardly towards the windows of the building. Finally, a pump is included which is adapted to affect the flow of the water from the reservoir tank through the pipes and to the sprinklers upon the receipt of an activation signal.

U.S. Pat. No. 6,450,264 discloses a sprinkler system for preventing brush and forest fires from engulfing a home. The sprinkler system includes a piping assembly being adapted to extend along a peak of a roof, the underside of eaves and along a fence line. It also includes a shield assembly including an elongate shield member being adapted to extend along the peak of the roof and shield support members being adapted to fasten to the roof of the building for supporting the elongate shield member; and further includes a water supply assembly being connected to the piping which includes a pump/control assembly.

U.S. Pat. No. 6,679,337 discloses a fire prevention system including a water sprinkler frame mounted on a house and having a plurality of sprayer nozzles. Also included is a water supply tank situated adjacent to the house and connected to the sprinkler frame with a pump coupled therebetween for supplying water to the water sprinkler frame upon the receipt of a heat signal. A plurality of temperature sensors mounted on the ground and spaced from a perimeter of the house or mounted to the top of the house are connected to the pump for transmitting the heat signal thereto upon the detection of a degree of heat greater than a predetermined amount.

U.S. Pat. No. 6,929,072 discloses a device and method for inhibiting the spread of a fire to the roof of a building by placing a base supporting a sprinkler and hose in fluid communication providing a source of water ejected from the sprinkler onto the roof. The interior of the base may be wetted to increase its weight. A rope, normally stored on a spool removably attached to the base, may be used to reposition the base on the roof.

U.S. Pat. No. 6,945,468 discloses a rainfall simulation apparatus for a structure, comprising a water source, an electric pump, a vertically oriented riser pipe, a perforated header pipe along the roof of the structure, a V-shaped aperture-containing trough connected to the roof, and an elongated collection bin below the trough and connected to the pump. A length of rope (20) allows an individual to pull the device onto the roof.

U.S. Pat. No. 6,945,468 discloses a rainfall distribution device that recirculates water from a catch basin for distribution across the roof of a structure.

U.S. patent application Ser. No. 11/680,803 entitled Process for Fire Prevention and Extinguishing, the contents of which is incorporated herein by reference. In this application, the Applicant discloses a process for retarding or extinguishing conflagrations using a superabsorbent polymer in water. The reaction of the water with the polymer creates a gel-like substance with a viscosity that allows the mixture to be readily pumped through a standardized 2.5 gallon water based fire extinguisher, yet viscous enough to cover vertical and horizontal surfaces to act as barrier to prevent fire from damaging such structures, minimizing the manpower need to continuously soak these structures.

U.S. Pat. No. 7,169,843 discloses absorptive, cross-linked polymers which are based on partly neutralized, monoethylenically unsaturated monomers carrying acid groups, and with improved properties, which has a high gel bed permeability and high centrifuge retention capacity.

U.S. Pat. No. 5,989,446 discloses a water additive for use in fire extinguishing and prevention. The additive comprises a cross-linked water-swellable polymer in a water/oil emulsion. The polymer particles are dispersed in an oil emulsion wherein the polymer particles are contained within discrete water “droplets” within the oil. With the help of an emulsifier, the water “droplets” are dispersed relatively evenly throughout the water/oil emulsion. This allows the additive to be introduced to the water supply in a liquid form, such that it can be easily educted with standard firefighting equipment.

U.S. Pat. No. 5,190,110 discloses the fighting of fires or protection of objects from fire by applying water, which comprises dispersing in the water particles of a cross-linked, water-insoluble but highly water-swellable acrylic acid derivative polymer in an amount insufficient to bring the viscosity above 100 mPa's. Advantageously, the particles are present in an amount such that after swelling the swollen particles hold 60 to 70% by weight of the total water, the polymer being a copolymer of an acrylic acid, the water containing silicic acid and/or a silicate as well as sodium, potassium or ammonium ions. The water is freely pumpable but the swollen particles adhere to surfaces they contact rather than running off rapidly.

U.S. Pat. No. 5,849,210 discloses a method of preventing or retarding a combustible object from burning including the steps of mixing water with a super absorbent polymer (“SAP”) to form one at least partially hydrated SAP, and applying the at least partially hydrated SAP to the combustible object, before or after combustion. In another embodiment, an article of manufacture includes a SAP, that is prehydrated, is useful for preventing a combustible object from burning, or preventing penetration of extreme heat or fire to a firefighter or other animal.

U.S. Pat. No. 6,372,842 discloses methods of using an aqueous composition or dispersion containing a water-soluble or water-dispersible synthetic polymer, and compositions formed thereof. The aqueous composition or dispersion is added to agricultural spray, ink, deicing, latex paint, cleaner and fire-extinguishing chemical compositions, water-based hydraulic compositions, dust control compositions and so on, to impart properties including, but not limited to, aerosol control, shear stability, transfer efficiency, oil/water reduction, emollient performance, lubricity, thickening, and anti-wear capability, to the resultant composition formed thereof.

U.S. Pat. No. 5,087,513 discloses polybenzimidazole polymer/superabsorbent polymer articles. These articles are prepared by either mixing the superabsorbent polymer particulates with the polybenzimidazole polymer solution during the formation of the polybenzimidazole article, or forming a composite of a polybenzimidazole film or fiber material layer with a superabsorbent polymer particulate containing layer. These polybenzimidazole products absorb large amounts of fluid while retaining the flame retardancy and chemical unreactivity of conventional polybenzimidazole materials.

U.S. Pat. No. 4,978,460 discloses a particulate additive for water for fire fighting containing a strongly swelling water-insoluble high molecular weight polymer as gelatinizing agent, which comprises a water-soluble release agent which causes the particles of said gelatinizing agent not to swell, the particles of the gelatinizing agent being encased or dispersed in the release agent. Suitable release agents include polyethylene glycol, sugars, mannitol, etc. The gelatinizing agent may be a moderately cross-linked water-insoluble acrylic or methacrylic acid copolymer.

U.S. Pat. No. 5,519,088 discloses an aqueous gel comprising a polymer of (meth)acrylamide or particular (meth)acrylamide derivative(s), particulate metal oxide(s) and an aqueous medium, a process for producing said gel, and products utilizing said gel. This aqueous gel can be produced so as to have transparency, has fire resistance and can prevent the spreading of flames, and is highly elastic. The aqueous gel when produced transparent, becomes cloudy when heated or cooled and is useful for the shielding of heat rays or cold radiation.

Thus what is needed in the yard is a device that can assist a homeowner in the last minute preparation of their structure in an attempt to retard advancements of fire.

### SUMMARY OF THE INVENTION

The instant invention is a dispenser and kit for use with a conventional pressure washer for coating of a structure. In particularly, the dispenser is an adapter that secures to the end of the pressure wand on a conventional pressure washer, wherein the high pressure flow from the pressure washer draws a super absorbent polymeric material which becomes saturated with water and can be distributed along with the pressurized water. The polymeric material not only retains water longer, it is believed that the material further shields the water from the heat of evaporation by containing of the water within the structure of the polymer, like an insulator.

In operation the pressure washer with the high pressure nozzle attached is capable of distributing fluid at the rate of about one and a half gallons/minute and the drawing approximately one and a half (1.5) gallons per minute. Pressure washers are known for their efficiency in use of water generating the water at a high pressure capable of projection long distances verses its common use of cleaning items with high pressure at close distances. The pressure washer allows the individual to easily spray the roof of the structure without need of standing on a ladder. As the pressure washer employs a pump it is also possible to draw water directly from a swimming pool should city or well water be unavailable.

It is an objective of the instant invention is to provide a low cost fire prevention kit for use by a homeowner.

Yet another objective of the instant invention is to provide a distribution wand that can be adapted to a conventional pressure washer capable of converting the pressure washer into a dispensing unit for a known fire retardant.

Another objective of the instant invention is to provide a pressurized water dispenser for super absorbent polymeric material that can be sprayed onto the structure for purposes of elongating the period of water attachment to the structure as well as providing a material that can be rewetted if evaporation occurs due to a lack of ambient moisture.

Yet still another objective of the instant invention is to provide an emergency kit that is non-hazardous and can be stored indefinitely.

Yet still another objective of the instant invention is to provide a device that does not alter the characteristics of a conventional pressure washer but rather supplements the use to provide a device capable of treating the roof structures without the need of ladders as trees or other items of concern that would otherwise be inaccessible without the tall ladder.

Still another objective of the instant invention is to provide a product that enhances the growth of vegetation.

Yet still another objective of the instant invention is to disclose a process for retarding or extinguishing conflagrations using a superabsorbent polymer in water at a rate viscous enough to cover vertical and horizontal surfaces to act as barrier to prevent fire from damaging such structures.

Yet still another objective of the instant invention is to employ a super absorbent polymer that is dehydrated to a powder for storage and capable of absorbing water up to several thousand times its own weight.

Yet another objective of the instant invention is to provide a composition to fight fires that is non-toxic, biodegradable and non-hazardous. If the fire hazard addressed is outdoors, the gel-like substance helps the soil recover from fire by maintaining higher moisture content of the soil for extended periods of time.

A further objective of the invention is to provide a composition to fight fires that will remain in solution, subsequently to being mixed with water, for an extended period of time.

Still another objective of the instant invention is to teach pre-treating combustibles (e.g., people, foliage, structures) to preventing them from reaching their ignition temperature.

Another objective of the instant invention is to teach a combination of water and super absorbent polymer having sufficient viscosity to enable it to cover and adhere to vertical and horizontal surfaces.

Yet another objective of the instant invention is to disclose an assembly, with a pick-up tube, and bucket of polymeric material that can be stored indefinitely for emergency use should a fire approach.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE DRAWINGS

FIG. 1 is a pictorial view of the instant invention in use for the coating of a structure;

FIG. 2 is a side view of the improved pressure washer wand of the instant invention;

FIG. 3 is top perspective view of the apparatus of the instant invention;

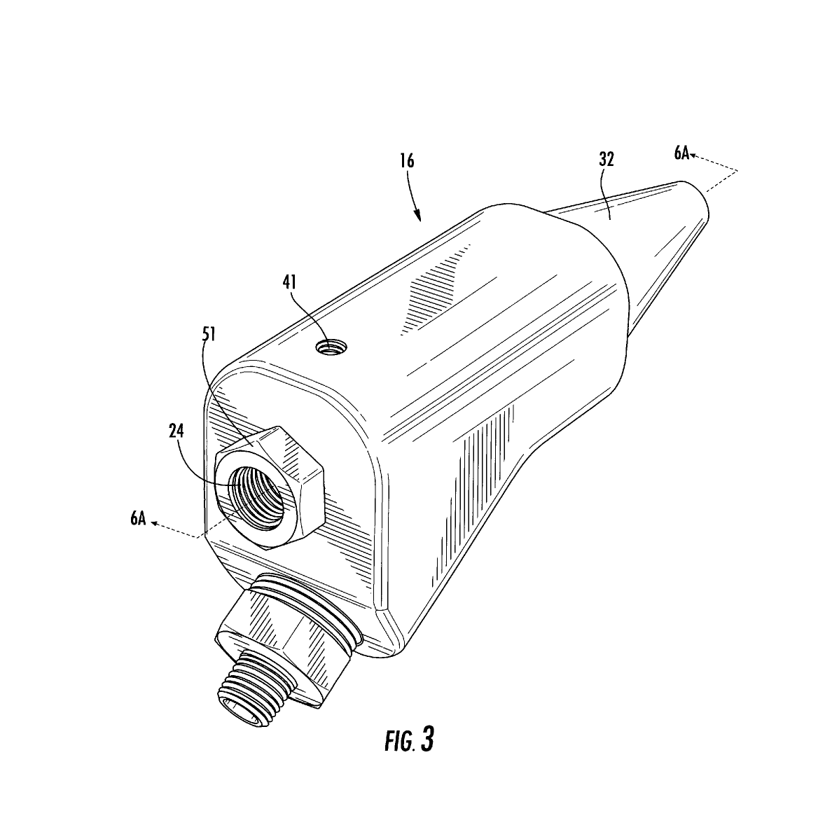

FIG. 4 is an exploded perspective view of the apparatus of the instant invention;

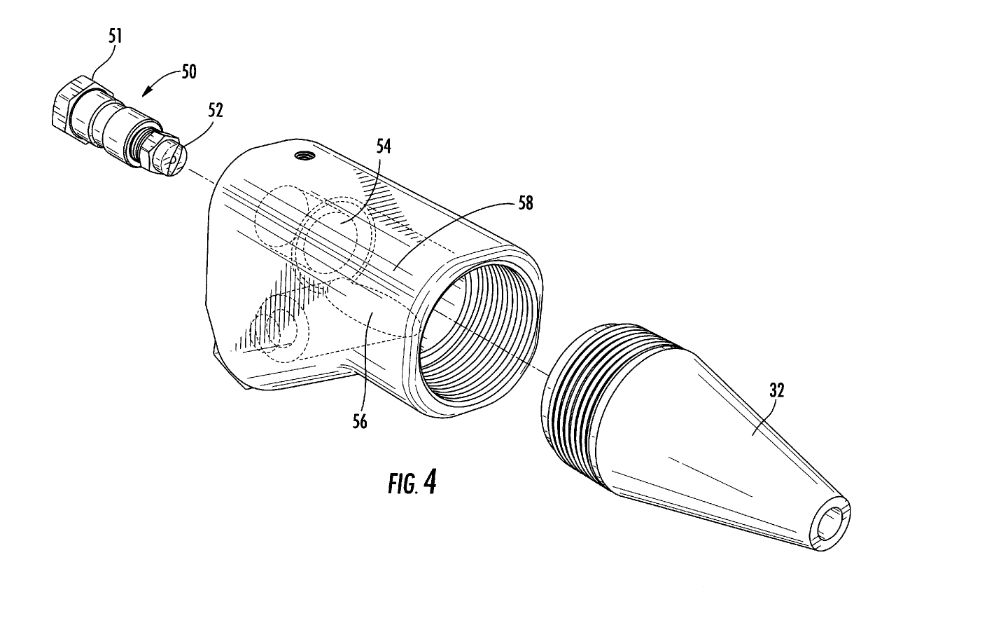

FIG. 5 is a partial perspective view of the apparatus of the instant invention; and

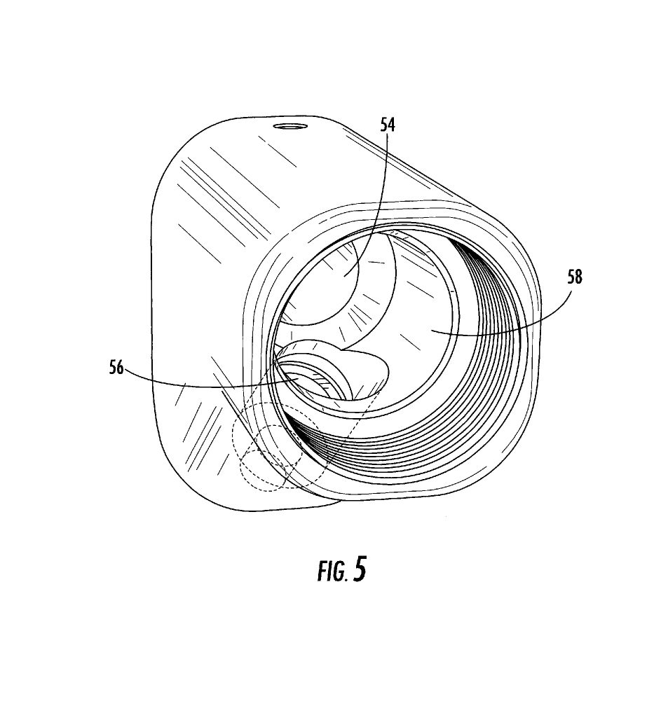

FIG. 6A is a cross sectional view as viewed along line 6A-6A of FIG. 3.

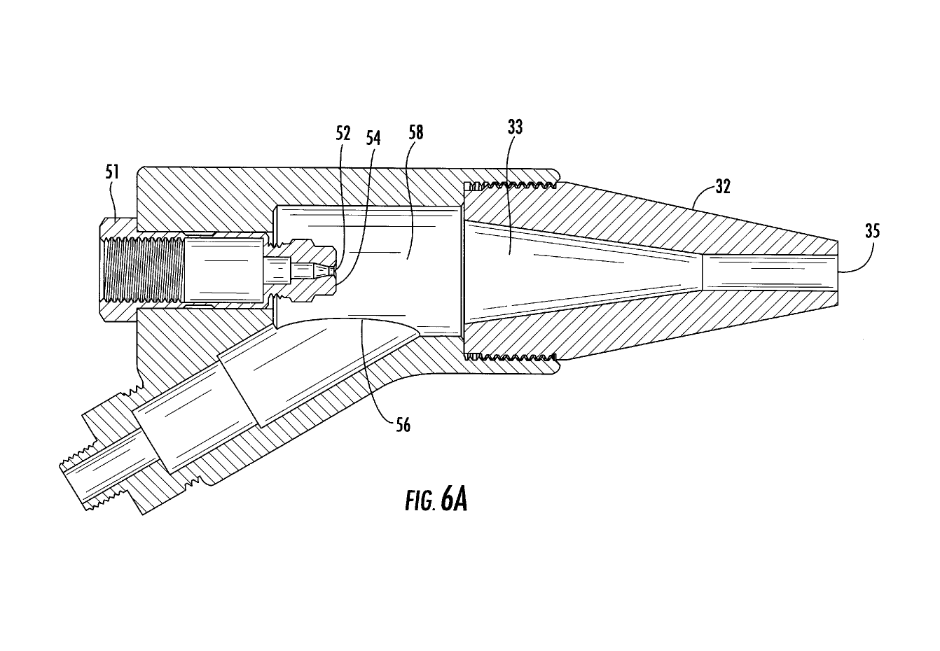

### DETAILED DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representative basis for teaching one skilled in the art to various employ the present invention in virtually any appropriately detailed structure.

The present invention relates to a composition for and process of retarding or extinguishing conflagrations using a super absorbent polymer in water in an amount sufficient to retard or extinguish the fire. The present invention utilizes biodegradable super absorbent, aqueous based polymers, for example, cross-linked modified polyacrylamides/potassium acrylate or polyacrylamides/sodium acrylate. Other suitable polymers include, albeit not limited to, carboxy-methylcellulose, alginic acid, cross-linked starches, and cross-linked polyaminoacids.

In the present invention, a solid form of the super absorbent polymer, such as a powder, is drawn into a water stream by use of an eductor at a rate that the resulting aqueous mixture of the super absorbent polymer and water have properties which enable the mixture to be sprayed onto and remain on vertical and horizontal surfaces of objects that are on fire. The adherence of the mixture to the surface of the object lowers the temperature of the object below the combustion temperature of the object, thereby extinguishing the fire. Alternatively the adherence of the mixture on the surface of the object maintains moisture content at a level to resist combustion of the object from hot embers. The preferred amount of powered super absorbent polymer added to flowing stream of water is about 2-5 ounces to 1.5 gallons of water.

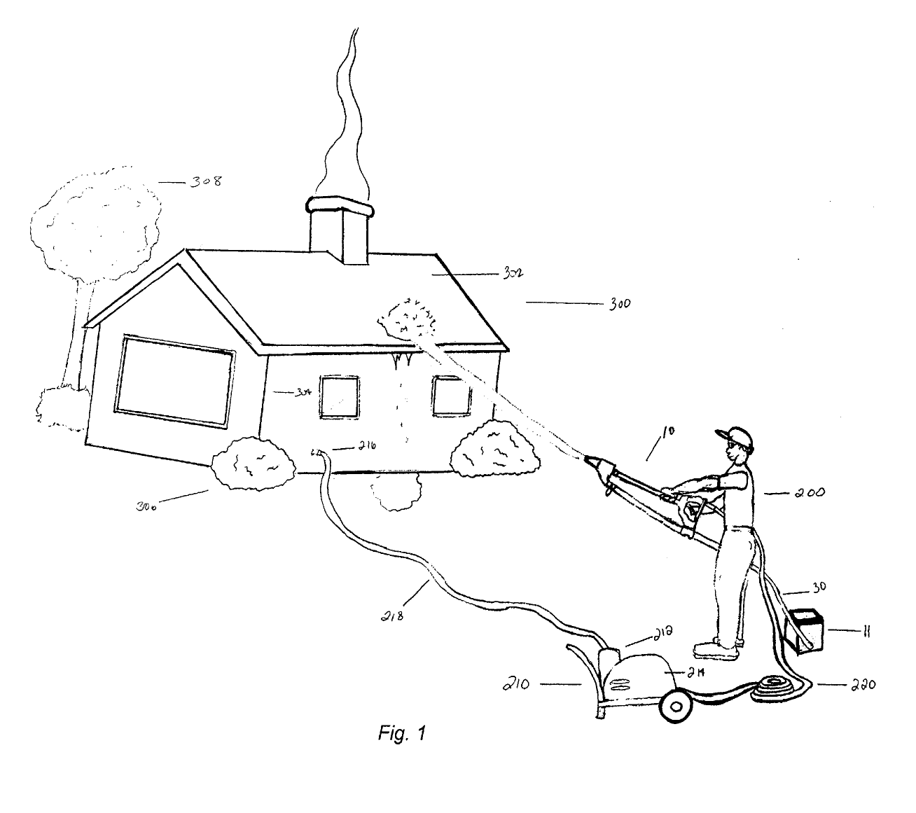

Now referring to FIG. 1, shown is a pictorial of an individual 200 standing before a structure 300 having a roof 302, vertical walls 304 and vegetation such as hedges 306 and trees 308. The individual 200 is applying the aforementioned composition for of super absorbent polymer in water onto the structure and surrounding vegetation. A conventional pressure washer 210 having a pump 212 driven by an internal combustion engine 214 receives water from a source, in this illustration a facet 216 provides a source of water to the pressure washer by a low pressure hose 218. The pressurized water is then directed through a high pressure hose 220 to a pressure washer wand 10. The wand 10 includes an apparatus for drawing dry super absorbent polymer from a container. The composition of polymer and water is then sprayed onto the structure. The pressurized water allowing the individual to coat a structure from a great distance thereby eliminating the need to climb upon the structure.

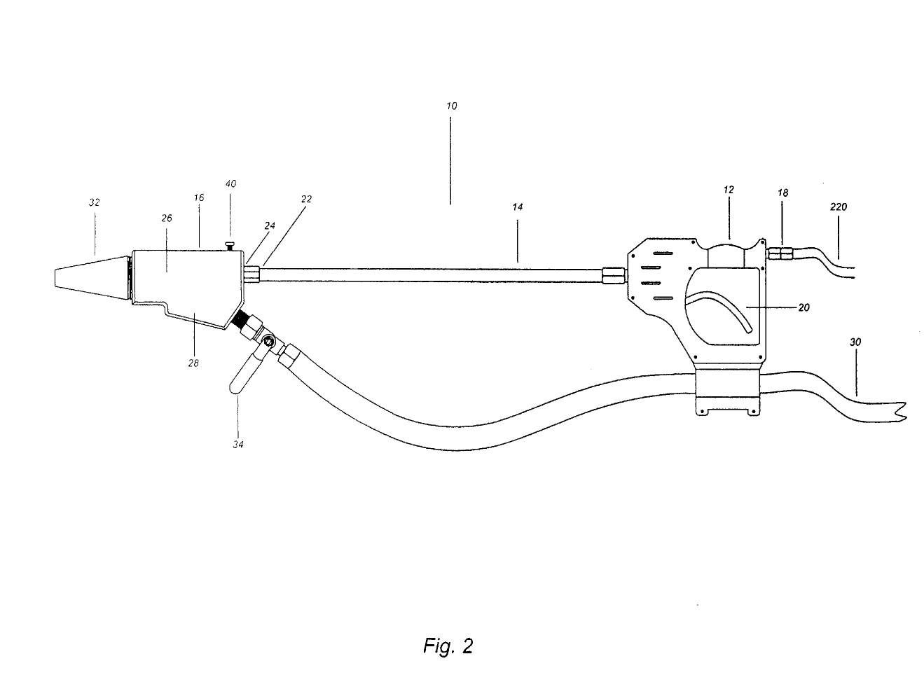

FIG. 2 depicts a modified pressure washer distribution wand for use in combination with the portable pressure washer for purposes of distributing the polymeric material used in enhancing the fire extinguishing properties of water. The pressure water distribution wand 10 is defined as a handle 12, an extension pipe 14, and a nozzle 16. The handle 12 includes an inlet connection 18 which is securable to the high pressure outlet of the portable pressure washer by a high pressure hose 220. The portable pressure washer may be an electric driven pump typically providing pressurized water up to 1500 PSI or a more robust pressure washer such as a conventional internal combustion engine that can produce from 2500 psi to 5500 psi. The invention can be adapted for use across a broad spectrum of pressure washers. The most commonly produced pressure washers operate at approximately 2600 PSI and draw approximately 2 ½ gallons per minute of water.

The pressure washer distribution wand includes a handle 12 with a manually operated trigger 20 to control the flow of pressurized fluid from the inlet 18 through the pipe 14 for discharge through end 22 which is connected to high pressure nozzle 50.

The pressure washer wand is connected to an apparatus 16 for converting a portable pressure washer into a pressurized dispenser of water having enhanced fire extinguishing properties. The apparatus 16 is comprised of a housing having a flow path extending axially from a fluid inlet 24 to a fluid outlet 35 with a mixing chamber 58 formed therebetween.

The mixing chamber 58 is constructed and arranged to draw dry polymeric material into the mixing chamber 58 when pressurized water is introduced into the fluid inlet 24 and discharged through high pressure nozzle tip 52. In a preferred embodiment, the nozzle tip is a 15° fan tip that discharges 1.5 GPM. As the discharge velocity of the water through nozzle tip 52 increases, the dry polymeric material is vacuumed through inlet 56 and enters into the mixing chamber 58. The fluid velocity of the water produces turbulence throughout the mixing chamber 58. The mixing chamber 58 is constructed and arranged to admix the dry polymeric material with the turbulent water. The pressurized water and extremely hydroscopic polymeric material is admixed in the mixing chamber and discharged through said fluid outlet discharge nozzle for use in coating surfaces without clogging the apparatus 16.

The dry powder inlet 56 is positioned at a predetermined oblique angle to the mixing chamber 58. The dry powder inlet 56 is coupled to a source of dry polymeric material 11.

The discharge nozzle tip 32 includes a frusto conical opening 33 that is tapered at an angle “A” of about 10 degrees. The composition is admixed and discharged as a mixture through outlet 33 of the nozzle tip 32. A manual control valve 34 is used to regulate the flow of polymeric material 11 through the intake tube 30 allowing the operator to control the draw rate of the polymeric material in a ratio of approximately 2 to 5 ounces for every 1 ½ gallons drawn. If the pressure washer flows at a rate of 1.5 gpm then the control valve can be adjusted to rate of draw of about 3 ounces per minute or about 120 ounces per hour.

In operation, the pressure washer can be used in its ordinary and conventional manner for use of cleaning of sidewalks, buildings and so forth. However, during an emergency, wherein a structure could be subjected to embers from an adjoining fire, the polymeric material may be distributed by use of the pressure washer by first attaching the nozzle 50 onto the end 22 of the wand with fitting 51. The fluid inlet 24 is sized to receive the high pressure nozzle 50. The high pressure nozzle 50 is secured in place by a fastener 40 constructed and arranged to cooperate with aperture 41. Intake tube 30 is placed within a container of super absorbent polymeric material and the control valve 34 adjusted to regulate the amount of material drawn into the mixing chamber 58 in combination with the depression of the trigger 20 of handle 12. For ease of setting, the control valve 34 may include indicia to indicate the proper positioning of the control valve based upon the flow rate from the pressure washer.

While the polymeric material is admixed with the fluid, it should be noted that the pressurized water allows for an enhanced incorporation of water into the polymeric material for instant distribution.. However, it should also be noted that a structure that is susceptible to fire is most likely in an extremely dry state and it has been found beneficial to first moisten the structure with water and then apply a coating of composition of polymeric material and water. In this application method, the mixture retains moisture for a longer period as the structure does not immediately draw upon the mixture to obtain a balance of moisture. The water application can be performed by use of the pressure washer with the control valve 34 rotated into an off position. Once the structure is moistened with water, the control valve 34 can then be opened wherein the mixture is applied to the structure. The polymeric material acts a partial shield to the structure wherein the structure moisture is held for a longer period of time, as compared to a moistened structure that is not coated. In addition, the mixture provides a ready source of moisture to maintain the structure moisture thereby enhancing the fire inhibiting properties of water.

The simplicity in design, as well as overall cost savings of a kit that can be used with a conventional pressure washer, provides a low cost applicator that can be used with most any manufactured pressure washer as an accessory item. The nozzle tip 32 consists of no moving parts and may be formed from an aperture that applies a stream flow, a spray pattern flow, or made adjustable. As the assembly draws the polymeric material into the mixing chamber 58, the turbulence in the mixing chamber 58 efficiently hydrates and discharges the super absorbent polymer and the possibility of clogging of distribution wand during application is eliminated. In addition, should the operator use non approved polymeric material, which might otherwise clog the apparatus 16 due to large particle swelling, the high pressure produced by the pressure washer is essentially self cleaning.

The pressure washer nozzle may also be adjusted or changed to provide a stream or spray that is most suitable for the application. A stream might be used for hard areas such as a two story home or a tall tree. A spray would be more suitable for coating a vertical wall with minimal passage. It should be emphasized that one of the advantages of the instant invention is that the operator need not climb upon the roof in order to reach an area that requires application. In addition, an adjustable spray nozzle is of assistance to accommodate the pressure of the incoming water. In some parts of California it is not uncommon to have municipal water pressure that exceeds 80 psi. In other instances the incoming pressure may be zero, such as when the incoming water is drawn from a swimming pool. When municipal water is applied the flow rate may be higher than normal than water drawn from a swimming pool having no pressure wherein the pressure would be lower than normal.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and drawings/figures. One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention. Although the invention has been described in connection with specific preferred embodiments, it should be understood that the invention should not be unduly limited to such specific embodiments.

What is claimed is:

1. An apparatus for converting a portable pressure washer into a pressurized dispenser of water having enhanced fire extinguishing properties comprising:
an housing having a flow path extending axially from a fluid inlet to a fluid outlet with a mixing chamber formed therebetween;
a fastener for securing the high pressure nozzle of the portable pressure washer to said fluid inlet, said fluid inlet sized to receive the high pressure nozzle;
a dry powder inlet positioned at a predetermined angle to said mixing chamber, said dry powder inlet coupled to a source of dry polymeric material; and
a discharge nozzle secured to said fluid outlet;
whereby said mixing chamber is constructed and arranged to draw dry polymeric material into said mixing chamber when pressurized water is introduced into said fluid inlet, the pressurized water and polymeric material is admixed in said mixing chamber and discharged through said fluid outlet discharge nozzle for use in coating surfaces.

2. An apparatus for converting a portable pressure washer into a pressurized dispenser of water having enhanced fire extinguishing properties according to claim 1 including an adjustable control valve to regulate the amount of dry polymeric material drawn into said chamber.

3. An apparatus for converting a portable pressure washer into a pressurized dispenser of water having enhanced fire extinguishing properties according to claim 1 wherein said high pressure nozzle includes a fan tip.

4. An apparatus for converting a portable pressure washer into a pressurized dispenser of water having enhanced fire extinguishing properties according to claim 1 wherein said polymeric material is further defined as a super absorbent polymeric material.

5. An apparatus for converting a portable pressure washer into a pressurized dispenser of water having enhanced fire extinguishing properties according to claim 1, whereby pressurized water forced though said inlet and said outlet of said apparatus pass through an area of reduced diameter to draw said polymeric material through said pick-up tube and into said mixing chamber.

6. An apparatus for converting a portable pressure washer into a pressurized dispenser of water having enhanced fire extinguishing properties according to claim 1, wherein said outlet of said assembly is adjustable between a low pressure discharge providing a wide angle of distribution and a high pressure discharge providing a pressurized stream of admixed fluid for coating areas that are otherwise unreachable without a ladder.

7. An apparatus for converting a portable pressure washer into a pressurized dispenser of water having enhanced fire extinguishing properties according to claim 1, wherein pressure washer distribution wand includes a manually operated flow trigger to regulate the flow of water through said inlet.

8. An apparatus for converting a portable pressure washer into a pressurized dispenser of water having enhanced fire extinguishing properties according to claim 7, wherein said polymeric material drawn through said dry powder inlet is controlled by said manually operated trigger.
